(19) United States
(12) Patent Application Publication
(10) Pub. No.: US 2015/0126794 A1
(43) Pub. Date: May 7, 2015

(54) Private user ethanol removal system

(71) Applicant: Jason C. Jones, Hurricane, UT (US)

(72) Inventor: Jason C. Jones, Hurricane, UT (US)

(21) Appl. No.: 13/998,501

(22) Filed: Nov. 5, 2013

(51) Int. Cl. C10L 1/04; B01D 17/02; B01D 11/04

(52) U.S. Cl. CPC C10L 1/04; B01D 11/04; B01D 17/0214; C10L 2290/544; C10L 2290/56
USPC 585/868; 210/511

(57) ABSTRACT

Removing ethanol from fuel by admitting the ethanol-containing fuel into a contained amount of water which is then mixed such that the ethanol-containing fuel may readily be separated into another container. Water and ethanol have an affinity for each other and separate away from the now ethanol-free fuel, and the water/ethanol mixture settles to a lower portion of the container. Once separated, the ethanol free fuel is readily removed into a separate container. The alcohol (ethanol) and water mixture is a valuable by-product of the invention, and is collected separately.

This is a privately conceived and funded invention free from any governmental involvement. This is a regular patent application that is being timely filed within the time period allotted from a Provisional Application entitled the same and filed on Nov. 5, 2012 having the same inventor as hereof and awarded Ser. No. 61/706,184.

The sole inventor has developed a new and unique configuration that enhances ethanol removal from gasoline by an inexpensive privately maintained accessory. The inventor, Jason C. Jones, has achieved a concept involving a novel structure that is worthy of patent protection in the fullest. The invention is presented herein by reference to figures, drawings, photographs and associated description which together amply demonstrate the novel and patentable features, method steps and structure of the invention.

### BACKGROUND AND FIELD OF THE INVENTION

This invention relates to the field of small gas powered engines and more particularly to private individual users of such equipment. The inventive method hereof finds particular strength in regard to novel steps and structures taken to improve our daily recreational-oriented activities.

It is recognized that a wide gamut of piston driven small engine applications should not—and must not—use ethanol blended gasoline. However, the blending practices and laws governing ethanol content are far from uniform and thus the user remains at risk. Protection of such an owner/user is a goal and accomplishment of this invention.

Ethanol test kits have become readily available in order to allow private users to test for the presence of and amount of ethanol in service station provided petroleum based fuel commonly referred to as E10 gasoline. The 10 signifies that up to 10 percent by volume is ethanol compared with the pure fuel at issue. Advocates seek instances wherein the percentage of alcohol (ethanol) in gas should be increased to 15% or “E15”.

Almost all conventional engine warranties only approve use of 10% (“E10”) fuel, and the factory engine warranty is voided if anything above 10% is employed. In actual practice, the percentage of ethanol varies with each and every fuel delivery to the commercial usage purchase location. Thus engine warranties, unknowingly, are often in danger of being voided without the owner/users knowledge or intent.

To further compound the above-noted problem, many service stations have stopped selling ethanol free (“E0”) gasoline at all. And, some states even mandate that ethanol must be bended into petroleum based gasoline and there are no exemptions from such governmental-mandated ethanol blending laws. A strong profit motive for more and more ethanol in fuel is backed by Governmental subsidies in the ethanol blended gasoline arena. In any event, however, ethanol percentages are not at all uniform and are generally outside the owner/users control. Nor is an accurate percentage blend required in printed form on a vast number of service station fuel island pumping equipment.

Moreover, some states are now removing the requirement that service station pumps must be accurately labeled as to whether or not the fuel being sold by that particular location does or does not actually contain ethanol. The ultimate owner/user is thus the single most entity that is at risk since some engines must not be subject to any ethanol containing fuel at all. Accordingly, a dangerous warranty and costly equipment repair or replacement situation has developed. It remains as established fact, however,—labeling requirements aside—that ethanol must not be used in certain vehicle engines.

Indeed, the presence of ethanol—regardless of percentage amount or labeling requirements—is deemed very harmful to every gasoline powered engine. Highly summarized, ethanol is harmful because its presence in fuel:
Rots and weakens rubber hoses:
Damages carburation parts:
Hurts fuel economy;
Attributes engine ping to engine operation;
Absorbs water and water-carried impurities into engine fuel;
Aversely shortens fuel storage life;
Damages fuel injectors, and rubber/plastic engine components;
Dries out and/or cracks hoses, seals and the like.

The above-noted summarization of harmful effects is not intended to be exhaustive. Other harmful effects are known to result from ethanol but may not be stated above. Be advised, nevertheless, that ethanol is added locally—not at the refinery. Thus no uniformity as to ethanol amounts in fuel being purchased is to be expected.

Recreational vehicles, in particular, are achieving high popularity and are very seriously in danger from ethanol presence in their fuel. Ethanol should not be used in 2 cycle engines as are today employed in most tools, lawnmowers, watercraft, snowmobiles, motorcycles and off-road 4 wheelers, dune buggies and the like. Antique cars, in particular, and many luxury vehicles as well should not use ethanol blended fuel.

Of paramount importance to all users is safety. And, such safety requires sound and safe equipment with focus on reliably expected octane and energy ratings. Reliability and safety are paramount factors behind the concepts of this invention as is further explained below. An owner, of course, desires reliable octane and energy performance from the fuel being consumed. Ethanol-containing fuel is susceptible to water contamination and phase separation, either of which deteriorates the performance factors of the fuel.

In general, ethanol is touted as a solvent, cleanser, degreaser, drying agent, antifreeze substitute, water-absorber and so-called octane enhancer. In actual practice, however, ethanol is highly unstable since it is attracts and absorbs water. Water in fuel is not desirable at all and degrades octane and energy performance characteristics.

Water and petroleum do not mix and thus potential harm is readily involved whenever ethanol is used under non-controlled situations such as those existing in our service-station-oriented environment. In short, ethanol blending can readily introduce many operational deficiencies that can cause serious octane/energy depletion and may result in harm to engine operation. Indeed, this invention takes advantage visibly of certain aspects of these stated deficiencies in accordance with its operational and structural arrangement. One ethanol factor considered a marked disadvantage is taken as an engineering principle that becomes a marked advantage in the invention. A new and unusual system arrangement and novel discovered methods concerning ethanol are disclosed and employed to advantage by the principles and structural operation of this invention.

A large majority of today's small engine users take specialized 5 or 10 gallon containers with them to obtain relatively small quantities of gasoline at their local service stations. Small trucks/RVs conveniently store extra fuel space. These convenience containers, as is well known, allow users to safely carry away a fixed quantity of ethanol-containing fuel from the local service station or distribution center. Ethanol must be removed from such containers for a great variety of reasons and equipment as was noted above. This invention readily accommodates such portable containers while it is not limited thereto.

Highly summarized, this ethanol remover invention provides a small compact mixing container in pipe or cylinder form for receiving a fixed quantity of regular water as may be drawn for example from a tap and introduced into said pipe/cylinder. According to the invention, Egas is pumped under pressure into the water contained within the mixing container. Such a cylinder may conveniently be made from a length of black plastic three inch diameter Schedule 40 pipe. A two foot length of such pipe will readily hold about 3 quarts of tap water introduced therein by a gravity feed fill tube. Three quarts of water, experience has shown, will suffice for several gallons of ethanol-containing gas

Associated with that water containing pipe cylinder is a mixing device for mixing or shaking the Egas under pressure into the water quantity stored in the mixing container. The inventor has discovered that the ethanol mixes and stays with the water in the bottom portion of the mixing cylinder; while ethanol free “E0” gas rises to the top of the contained water in the cylinder. Water mixed with removed ethanol takes on a milky white or murky color. The invention use this color change to advantage in his invention, as explained further below.

Associated with and positioned at the top of the cylinder is a clear sight tube which visually exposes ethanol free murky color achieved by mixing action within the cylinder. Vigorously mixing admitted Egas with the contained water causes a distinct separation of pure gas and ethanol as mixed under pressure with the cylinder-contained water. In operation, a flexible hose is inserted into the portable Egas container and such Egas is pump driven through appropriate valves and tubing into the mixing chamber. Windshield spray nozzles have achieved a satisfactory mixing action although other mixing devices may be employed. The Egas and water, vigorously mixed together, causes the ethanol to fully separate from the gas due to the affinity that ethanol exhibits for water. This mixed ethanol and water conglomerate and sink to the bottom of the cylinder whereas E0—ethanol free gas—rises to the top of the contained water in the cylinder.

A simple visual inspection via the inventions transparent sight tube allows the E-removed gas to be drawn away into another container. The invention tests have shown that the shape of the mixing container is not critical. Also the inventor has discovered that plates within the mixing container can be used to advantage for removal of air bubbles should those bubbles prove harmful. It is the inventor's experience that the apparatus of his FIG. 3 does have bubbles, but he has found that their presence does not adversely affect the result achieved by his ethanol removal system. Indeed, tests confirm that 100 percent of the ethanol was cheaply and safely removed from the Egas that was originally introduced into this private ethanol removal system of FIG. 3 and that the bubbles did not affect the desired results.

Accordingly, what has been needed—but was not yet provided prior to the advent of this invention—was a simple yet straightforward solution to the above-described ethanol removal problem. On a private individual basis a simple effective tool has been provided which utilizes a careful balance of existing technology with inexpensive common place component parts to achieve a new and unexpected result and desired performance. This invention thus provides an ethanol removing system via simple effective means from ordinary economical components and yields a major improvement in fuel handling and care for small engine equipment for a variety of equipment types.

Additionally, many of the above noted factors bring the convenience and safety of the individual engine owner into play whereby he may more readily provide safety and convenience for his piston driven equipment irrespective of its use or location. In short summary, what is needed is a better way, and a new improvement and combination of standard components has been provided which in combination yield both a new and useful method and a novel apparatus for private ethanol removal.

### SUMMARY OF THE INVENTION

Please see the enclosed pictures and sketches taken together with the written description. The private user ethanol removal invention, it should be noted, is not yet fully commercially developed nor is it priced or available beyond a Research & Development final prototype stage. It has not yet been made available to the public nor is it on sale. Instead, it is approaching the final stages of perfection and the filing of this regular patent application takes place before any sale, disclosure or public use of the invention has taken place.

An improved method and/or apparatus of removing ethanol from fuel by a removal system comprising the steps described and depicted in FIGS. 1 through 3 hereof by virtue of mixing ethanol-containing gasoline with water and comprising providing a container of water into which ethanol-containing gasoline may be admitted under slight pressure; mixing the fuel under said pressure with said contained water; settling the mixture of water and ethanol toward a lower portion of said container; separating the ethanol free fuel from the settled water and ethanol mixture; and removing the ethanol free fuel from said container.

A method of removing ethanol from fuel in a system having contained water, by the steps consisting essentially of:

mixing ethanol-containing fuel into the contained water thus allowing the fuel to float to the top of the contained water in the system;

continuing to introduce more ethanol-containing fuel into the system during a continuous operation of said ethanol removal; and

draining ethanol free fuel off the top of the water.

### BRIEF DESCRIPTION OF THE DRAWING

Several sketches and photographs (FIGS. 1 through 3) illustrate the principles of the method and apparatus of this invention. In order to help the Patent Office Examiner better understand my invention, the inventor herein describes the apparatus and process involved by reference to these various Figures.

FIG. 1 includes FIGS. 1A, 1B and 1C;

FIG. 2 is a sketch depicting a component layout; and

FIG. 3 shows the inventive system presented upon a mounting board.

### DETAILED DESCRIPTION OF THE INVENTION

FIG. 1A is a basic block diagram of the ethanol removal system invention. FIG. 1B depicts a sketch of additional details concerning the system of FIG. 1A. In FIG. 1A, E10 or E15 fuel in container 20 is supplied via pump pressure from pump 22 into a mixing and separating chamber 25. Ethanol free gas is separated by the mixing element 30 at component 25 in the manner described previously. One of the difficulties of the removal system was how to get the pure gas (ethanol free gas, E0) out of the system into another container or holding tank 35. FIG. 1C depicts some of my early considerations concerning filtering layers 36 with several different configurations of surfaces and openings therein being provided so as to assist in and enable the E0 removal process with a bubble reduced system operation.

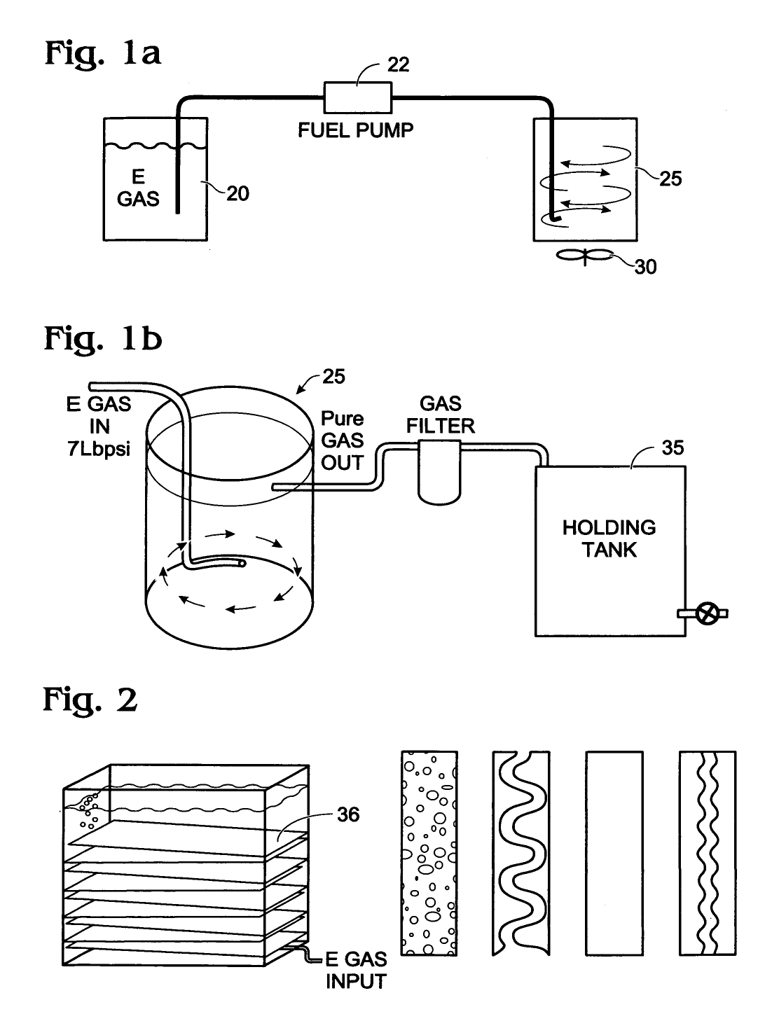

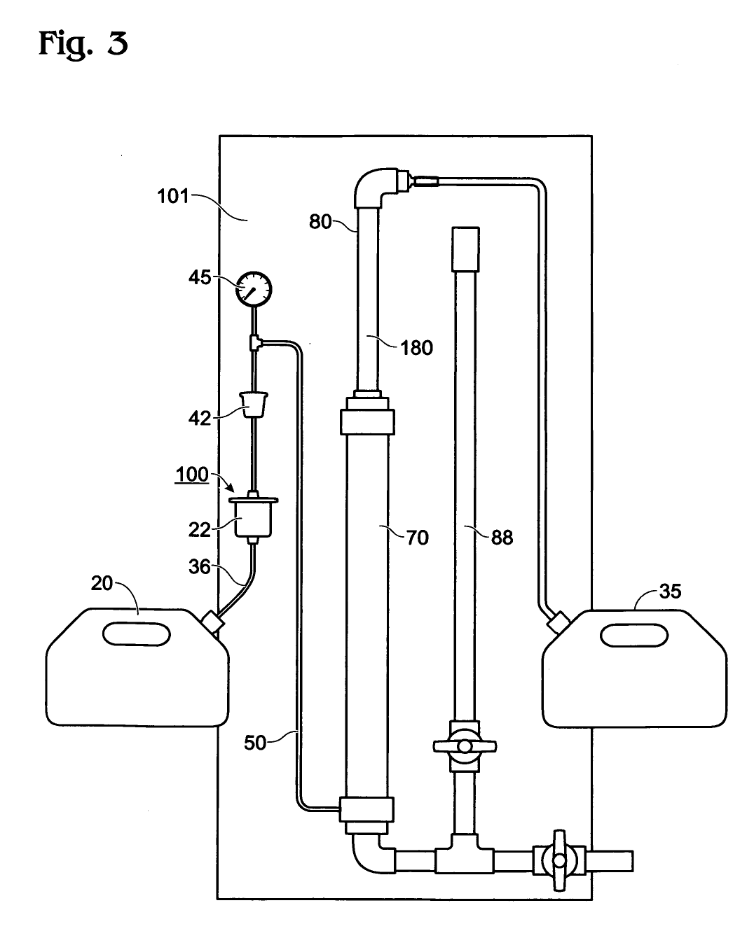

FIG. 2 is a sketch depicting a component layout useful for explaining the operation of my ethanol removal invention. In the sketch of FIG. 2 a battery operated system is shown. The operation of FIG. 2 and the components of FIG. 3 are essentially the same. Thus the detailed description of the actual system of FIG. 3 will suffice for both Figures.

FIG. 3 shows the system 100 presented upon a mounting board 101. The overall height of the system is about four feet and thus it may conveniently be mounted on a wall or it can be made in a free standing configuration as desired. In my FIG. 3, a round mixing pipe is employed whereas in my FIG. 1C a square mixing container also will work well. These various figures of my drawing further demonstrate the method and apparatus of the invention and are believed to be self explanatory in view of the written description that follows.

For ease of presentation, my invention has been shown and described by my coined term as “Ethanol-B-Gone™”. My novel Ethanol-B-Gone device is designated in FIG. 1A as device 100. That device 100 is depicted as positioned to the left of a typical 5 gallon Egas input container 20. The container 20 is filled with an ethanol containing gas that would be purchased from a local service station or distribution center. Extending from container 20 is a tube 36 connected to the suction side of pump 22 that has its pressure supply side connected through a filter 42 which is connected in turn to an input supply line 50. Gauge 45 is in line on the input side and gauge 45 monitors the pressure applied by pump 22 to the inlet supply line 50. In this configuration input line 50 is connected to the inlet bottom side of a standing three inch diameter PCV pipe 70.

Also connected to the bottom of pipe 70 through appropriate valves is a standing water fill pipe 88. Fill pipe 88 is used at the start of an ethanol removal operation by placing about 3 quarts of regular tap water into the interior of pipe 70. Pipe 70 is thus partially filled with tap water before an ethanol-containing gas “Egas” is introduced into pipe 70 from container 20 via activation of pump 22 and inlet line 50. Pump 22, with about 4 to 7 pounds per square inch of positive pressure, forces Egas into the pipe 70 via line 50.

A mixing action takes place between the contained water and the incoming Egas. This mixing action is signified by a swirling motion as symbolically depicted by arrows 75 in FIG. 1B. Mixing or swirling the Egas (see arrow pattern 75 FIG. 1B) under pressure into the water stored in pipe 70 results in a new and novel discovery and highly advantageous result. I discovered that the ethanol mixes freely into the water and stays with the water in the bottom portion of the mixing cylinder 70, while ethanol free E0 gas rises to the top and floats on the upper water surface in cylinder 70.

Positioned at the top of cylinder 70 is a clear sight tube 80 which visually exposes the results achieved by this mixing action within cylinder 70. Vigorously mixing admitted Egas with the contained water causes a distinct separation of pure gas and the ethanol as mixed under pressure with the cylinder-contained water. A line of demarcation 180 is present in sight tube 80 as the purification process is being concluded. It is a simple matter to note the slowly rising demarcation line 180 rising in sight tube 80 and thus recognize that the ethanol removal process is drawing to a close.

Windshield spray nozzles located at the output of line 50 with the pressurized jets input into the swirl developing in tube 70 have proven to achieve a satisfactory mixing action as ethanol containing gas is forced into pipe 70. The Egas and water, vigorously mixed together, causes the ethanol to fully separate as a murky liquid from the purified gas due to the strong affinity which ethanol exhibits for water. In the sight tube the mixture of ethanol and water due perhaps to the presence of tiny bubbles is a milky white color which readily allows the operator to clearly identify the demarcation line between pure gas and the ethanol-removed byproduct liquid.

This ethanol and water conglomerate mixes together and stays in position toward the bottom of the cylinder 70, whereas E0—ethanol free gas—rises to the top of the water in cylinder 70. A line of clear demarcation 180 exists between the mixture and the purified Egas. That line 180 begins to appear and moves upward in sight tube 80 as the removal operation is being concluded.

Visual inspection via the transparent sight tube 80 allows the E-removed gas to be drawn away into another container 35 as ethanol free gas. I have tested and confirmed that essentially 100 percent of the ethanol and water has thus been removed from the Egas originally introduced into my private ethanol removal system 100. An important by product of this invention is the murky ethanol and water mixture drained from pipe 70 after ethanol removal is accomplished.

Valves connected to the bottom of pipe 70 easily and quickly allows for removal of this byproduct. I have found several valuable uses for the byproduct including use as a purifying agent, solvent, degreaser, anti freeze supplement and a drying agent with chemical properties. Other uses are being researched at this time.

While my pictures and sketches herein are shown in a circular form as components of my invention, pipe 70, water fill tube 88 etc. may take any number of shapes while still accomplishing my stated objectives as described herein. Please note that the plastic pipe components are very economical, and thus this system is inexpensive to produce in quantity, and achieves a salutary result not heretofore found in the prior art. Other shapes and configurations are thus possible without departing from the scope and power of this invention.

What has been depicted and described is a new method and apparatus for ethanol removal. The invention is safe, easy to use and achieves objectives not heretofore achieved by any other known prior art devices. The invention provides many non obvious features and advantages over the prior art.

1. A method of removing ethanol from fuel in a system having contained water, by the steps consisting essentially of:
mixing ethanol-containing fuel into the contained water to thereby allow the mixture to float in the contained water in the system;
continuing to introduce more ethanol-containing fuel into the system while mixing the fuel and the water during a continuous operation of said ethanol removal;
allowing the water and ethanol to settle away from the ethanol free fuel; and
draining ethanol free fuel away from the water.

2. The method of claim 1 and consisting of the additional step of placing the
drained ethanol free fuel into a container separate from the water container.

3. The method of claim 1 wherein said water is initially introduced into a cylindrical storage pipe compartment, which compartment has a top and a bottom.

4. The method of claim 1 wherein the mixing step further includes;
pumping the fuel into the bottom of the storage compartment via an inlet nozzle.

5. The method of claim 1 wherein the draining step includes;
selectively allowing only the fuel in the storage compartment to escape via an outlet nozzle connected at the top of the storage compartment.

6. The method of claim 5 wherein the draining step is visually controlled by a sight tube connected to the top of the storage compartment.

7. The method of claim 6 wherein the sight tube allows a visual control for a user in order to show when the water comes up into the sight tube thus allowing the drain valve to be opened.

8. An apparatus of removing ethanol from fuel by a removal system comprising the
a container of water into which ethanol-containing gasoline may be admitted under slight pressure;
a mixer for mixing the fuel under said pressure with said contained water;
a lower space within said container for settling the mixture of water and ethanol toward said lower portion of said container;
means for separating the ethanol free fuel from the settled water and ethanol mixture; and
means for removing the settled ethanol free fuel from said container.

9. (canceled)

10. (canceled)

11. A container method of removing ethanol from fuel by the steps consisting essentially of:
containing an amount of water into which ethanol-containing gasoline may be admitted;
mixing ethanol-containing fuel with water in a container;
settling the mixture of water and ethanol toward a lower portion of said container;
separating the ethanol free fuel from the settled water and ethanol mixture; and
removing the ethanol free fuel from said container.
